(19) United States
(12) Patent Application Publication
(10) Pub. No.: US 2017/0223321 A1
(43) Pub. Date: Aug. 3, 2017

(54) PROJECTION OF IMAGE ONTO OBJECT

(71) Applicant: Hewlett-Packard Development Company, L.P., Houston, TX (US)

(72) Inventor: Jinman Kang, San Diego, CA (US)

(21) Appl. No.: 15/501,005

(22) PCT Filed: Aug. 1, 2014
(86) PCT No.: PCT/US2014/049321

§ 371 Date: Feb. 1, 2017

(51) Int. Cl. H04N 9/31; G01S 17/42

(52) U.S. Cl. CPC H04N 9/3185; H04N 9/3194; G01S 17/42; H04N 9/3141

(57) ABSTRACT

An image system including a sensor cluster module to detect and capture surface area values of an object and communicate surface area values to a computing device and a projector to receive boundary values related to the surface area values of the object and image content of an image from the computing device, the projector to project the image content within and onto the surface area of the object.

### BACKGROUND

Image-based modeling and rendering techniques have been used to project images onto other images (e e:,, techniques used in augmented reality applications). Augmented reality often includes combining images by superimposing a first image onto a second image viewable on a display device such as a camera, liquid crystal display, for example.

### BRIEF DESCRIPTION OF THE DRAWINGS

FIG. 1 is a diagram illustrating an example of an image system in accordance with the present disclosure.

FIG. 2 is a diagram illustrating an example of an image system in accordance with the present disclosure.

FIGS. 3A and 3B are front views illustrating an example of an image system in accordance with the present disclosure.

FIG. 4 is a front view illustrating an example of an image system including a remote system in accordance with the present disclosure.

FIGS. 5A and 5B are front and side views illustrating an example of an object in accordance with the present disclosure.

FIG. 6 is a front view illustrating an example of an image system including a remote system and a wedge object in accordance with the present disclosure.

FIG. 7 its a flow diagram illustrating an example method of displaying an augmented image in accordance with the present disclosure.

### DETAILED DESCRIPTION

In the following detailed description, reference is made to the accompanying drawings which form a part hereof, and in which is shown by way of illustration specific examples in which the disclosure can be practiced. It is to be understood that other examples can he utilized and structural or logical changes can be made without departing from the scope of the present disclosure. The following detailed description, therefore, is not to he taken in a limiting sense, and the scope of the present disclosure is defined by the appended claims. It is to be understood that features of the various examples described herein can be combined, in part or whole, with each other, unless specifically noted otherwise.

Examples provide systems and methods of projecting an image onto a three-dimensional (3D) object. For purposes of design, visualization, and communication it is helpful to create augmented displays of images on physical objects, the objects typically being 3D objects. Examples allow for projected content of an image to be aligned with a perimeter, or boundary, of the 3D object and the image content overlaid onto the object for display. In accordance with aspects of the present disclosure, the image content is sized and positioned for projection limited to only within the boundary of the object. In other words, regardless of the shape, size, or location of the 3D object, the image will be adjusted as suitable to fit within the boundary (i.e., within the size, shape, and location) of the object. The image can he based on two-dimensional (2D) or three-dimensional (3D) objects.

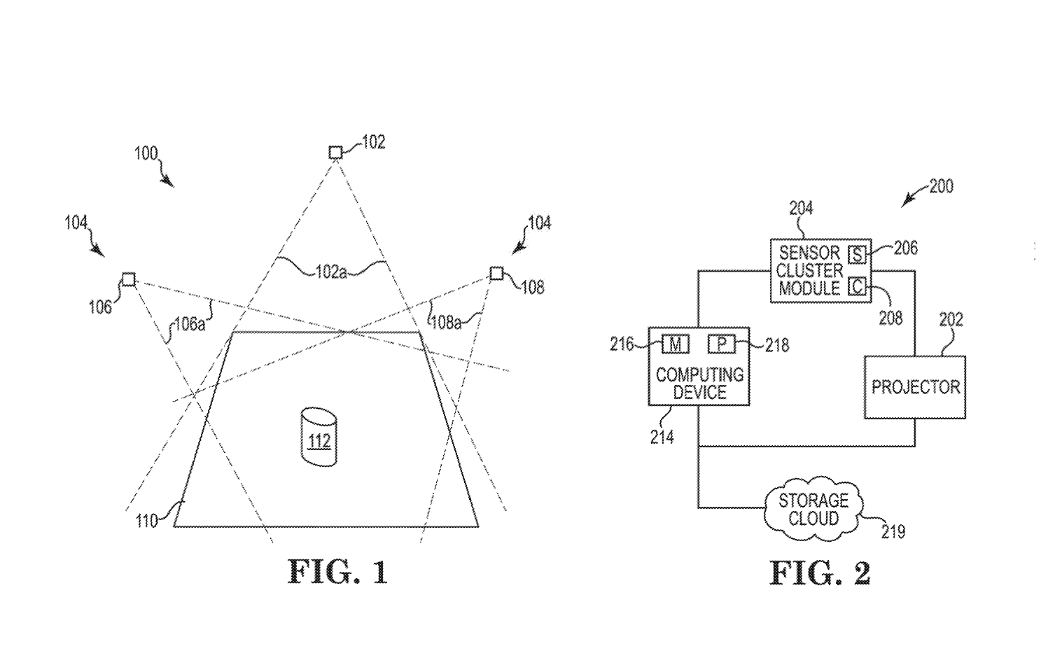

FIG. 1 a diagrammatic illustration of an example of an image system 100 including a projector 102 and a sensor cluster module 104. In the example illustrated, sensor cluster module 104 includes a depth sensor 106 and a camera 108. Projector 102 has a projector field of view (FOV) 102a, depth sensor 106 has a depth sensor FOV 106a, and camera 108 has a camera FOV 108a. In operation, projector FOV 102a, depth sensor FOV 106a, and camera FOV 108a are at least partially overlapping and are oriented to encompass at least a portion of a work area surface 110 and an object 112 positioned on surface 110. Camera 108 can be a color camera arranged to capture either a still image of object 112 or a video of object 112. Projector 102, sensor 106, and camera 108 can he fixedly positioned or adjustable in order to encompass and capture a user's desired work area.

Object 112 can be any 2D or 3D real, physical object, in the example illustrated in FIG. 1, object 112 is a cylindrical object, such as a tube or cup. Positioned in the combined FOVs 106a, 108a, the surface area of the real 3D object 112 is recognized. Using depth sensor 106 and camera 108 of sensor cluster module (SCM) 104, surface area values related to object 112 are detected and captured. Closed loop geometric calibrations can be performed between all sensors 106 and cameras 108 of the sensor cluster module 104 and projector 102 to provide 2D to 3D mapping between each sensor/camera 106, 108 and 3D object 112. Sensor cluster module 104 and projector 102 can be calibrated for real time communication.

Sensor cluster module 104 includes a plurality of sensors and/or cameras to measure and/or detect various parameters occurring within a determined area during operation. For example, module 104 includes a depth sensor, or camera, 106 and a document camera (e.g., a color camera) 108. Depth sensor 106 generally indicates when a 3D object 112 is in the work area (i.e., FOV) of a surface 110. In particular, depth sensor 106 can sense or detect the presence, shape, contours, perimeter, motion, and/or the 3D depth of object 112 (or specific feature(s) of an object). Thus, sensor 106 can employ any suitable sensor or camera arrangement to sense and detect a 3D object and/or the depth values of each pixel (whether infrared, color, or other) disposed in the sensor's field of view (FOV). For example, sensor 106 can include a single infrared (IR) camera sensor with a uniform flood of IR light, a dual IR camera sensor with a uniform flood of IR light, structured light depth sensor technology, time-of-flight (TOP) depth sensor technology, or some combination thereof. Depth sensor 106 can detect and communicate a depth map, an IR image, or a low resolution red-green-blue (RGB) image data. Document camera 108 can detect and communicate high resolution RGB image data. In some examples, sensor cluster module 104 includes multiple depth sensors 106 and Cameras 108 as well as other suitable sensors. Projector 102 can be any suitable projection assembly suitable for projecting an image or images that correspond with input data. For example, projector 102 can be a digital light processing (DLP) projector or a liquid crystal on silicon (LCoS) projector.

FIG. 2 illustrates an example of an image system 200 in accordance with aspects of the present disclosure. System 200 is similar to system 100 discussed above. System 200 includes a projector 202 and a sensor cluster module 204. System 200 also includes a computing device 214. Computing device 314 can comprise any suitable computing device such as an electronic display, a smartphone, a tablet, an all-in-one computer (i.e., a computer board including a display), or some combination thereof, for example. In general, computing device 214 includes a memory 216 to store instructions and other data and a processor 318 to execute the instructions.

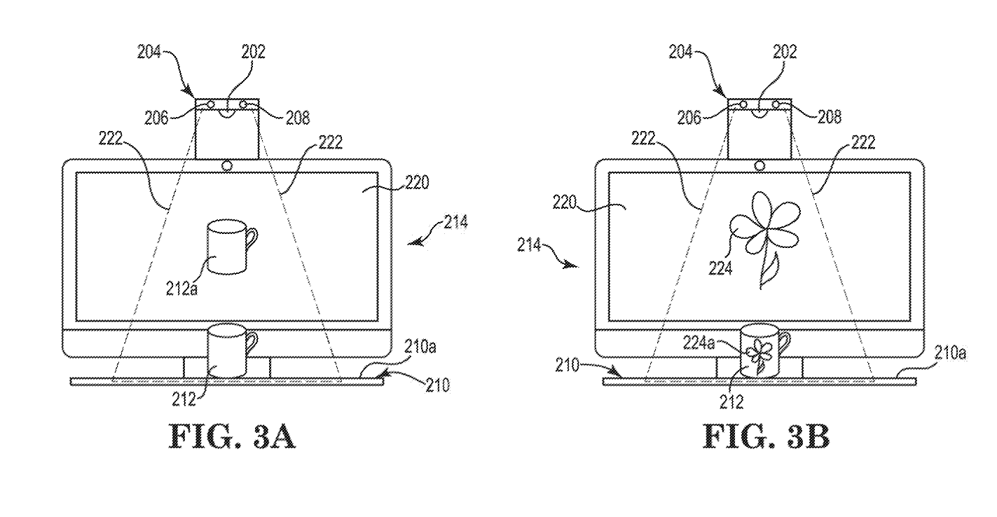

With additional reference to FIGS. 3A and 3B, in one example, a depth sensor 206 and a camera 208 of sensor cluster module 204 are coupled to, or are part of, computing device 214. Alternatively, all or part of sensor cluster module 204 and projector 202 are independent of computing device 214 and arc positioned on or near a surface 210 onto which an object 212 can be positioned. Regardless, projector 202, sensor cluster module 204, and computing device 214 are electrically coupled to each other through any suitable type of electrical coupling. For example, projector 202 can be electrically coupled to device 214 through an electric conductor, WI-FI, BLUETOOTH®, an optical connection, an ultrasonic connection, or some combination thereof. Sensor cluster module 204 is electrically and communicatively coupled to device 214 such that data generated within module 204 can be transmitted to device 214 and commands issued by device 214 can be communicated to sensors 206 and camera 208 during operations.

In the example illustrated in FIGS. 3A and 3B, device 214 is an all-in-one computer. Device 214 includes a display 220 defining a viewing surface along a front side to project images for viewing and interaction by a user (not shown). In some examples, display 220 can utilize known touch sensitive technology for detecting and tracking one or multiple touch inputs by a user in order to allow the user to interact with software being executed by device 214 or some other computing device (not shown). For example, resistive, capacitive, acoustic wave, infrared (IR), strain gauge, optical, acoustic pulse recognition, or some combination thereof can be included in display 220. User inputs received by display 220 are electronically communicated to device 214.

With continued reference to FIGS. 3A and 3B, projector 202 can be any suitable digital light projector assembly for receiving data from a computing device (e.g., device 2141 and projecting an image or images that correspond with that input data. In some examples, projector 202 is coupled to display 220 and extends in front of the viewing surface of display 220. Projector 202 is electrically coupled to device 214 in order to receive data therefrom for producing light and images during operation.

FIG. 3A illustrates system 200 with object 212 positioned on first side 210a of surface 210. Dashed lines 222 indicates a combined FOV of projector 204, sensor 206, and camera 208 oriented toward surface 210. Sensor 206 and camera 208 can detect, and capture surface area values associated with the recognized surface area of object 212. Captured values can be electronically transmitted to computing device 214.

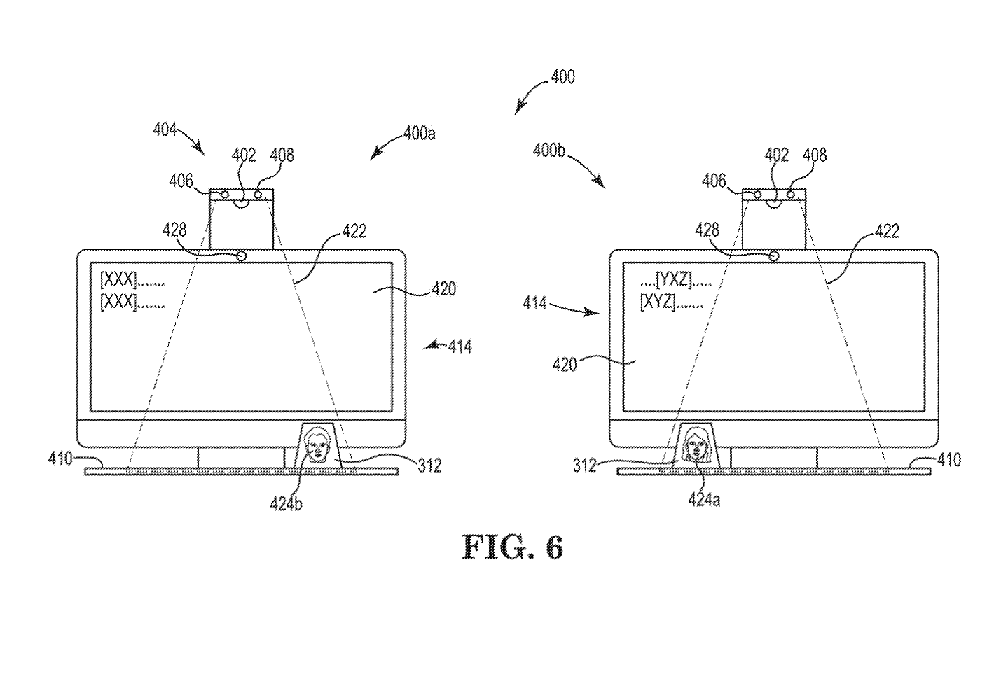

Memory 216 of computing device 214 illustrated in FIG. 2 stores operational instructions and receives data including initial surface area values and image values associated with object 212 from sensor cluster module 204. Surface area values, for example, can also be communicated with and stored for later access on a remote data storage cloud 219. As illustrated in FIG. 3A, an object image 212a of object 212 can be displayed on computing device 214 or a remote computing device (see, e.g., FIG. 6). Processor 218 executes the instructions in order to transform the initial surface area values into boundary line values. A technique such as a Hough transformation, for example, can be used to extract boundary line values from the digital data values associated with object 212. A boundary (i.e., shape, size, location) of object 212 can be approximated from the boundary line values. In addition, and with reference to FIG. 313, processor 21$ can transform image values of an image 224 (e.g., a flower) to he within a vector space defined by the boundary line values associated with object 212 and generate image values confined by, and aligned with, the object boundary of object 212, image 224 can be any image stored in memory 216 or otherwise received by processor 218. Projector 202 receives the aligned image values from processor 218 of device 214 and generates an aligned image 224a and projects the aligned image onto object 212.

Surface area of the 3D object 212 is recognized using depth sensor 206 in the sensor cluster module 204 and aligned image 224a is overlaid on object 212 using projector 202 while the projected content (e.g., picture) is aligned with the boundary of object 212, in order that the projected content 224a is overlaid on object 212 only. Image content of image 224 is, automatically adjusted as appropriate to be projected and displayed on object 212 as aligned image 224a. In other words, image content of image 224 can be projected within a first boundary (e.g., size, shape, location) of a first object and the same image content can be realigned and projected within a second boundary (e.g., size, shape, location) of a second object, with the first boundary being different than the second boundary. Closed loop geometric calibrations can be performed as instructed by device 214 (or otherwise instructed) between all sensors in sensor cluster module 204 and projector 202. Calibration provides 2D to 3D mapping between each sensor and the real 3D object 212 and provides projection of the correct image contents on object 212 regardless of position within the FOV of projector 202.

In some examples, surface 210 is an object platform including a first or front side 210a upon which object 212 can be positioned. In some examples, surface 210 is a rotatable platform such as a turn-table. The rotatable platform surface 210 can rotate a 3D object about an axis of rotation to attain an optimal viewing angle by sensor cluster module 204. Additionally, by rotating surface 210, camera 208 can capture still or video images of multiple sides or angles of object 212 while camera 208 is stationary. In other examples, surface 210 can be a touch sensitive mat and can include, any suitable touch sensitive technology for detecting and tracking one or multiple touch inputs by a user in order to allow the user to interact with software being executed by device 214 or some other computing device (not shown). For example, surface 210 can utilize known touch sensitive technologies such as, for example, resistive, capacitive, acoustic wave, infrared, strain gauge, optical, acoustic pulse recognition, or some combination thereof while still complying with the principles disclosed herein. In addition, mat surface 210 and device 214 are electrically coupled to one another such that user inputs received by surface 210 are communicated to device 214. Any suitable wireless or wired electrical coupling or connection can he used between surface 310 and device 214 such as, for example, WI-FI, BLUETOOTH®, ultrasonic, electrical cables, electrical leads, electrical spring-loaded pogo pins with magnetic holding force, or some combination thereof, while still complying with the principles disclosed herein.

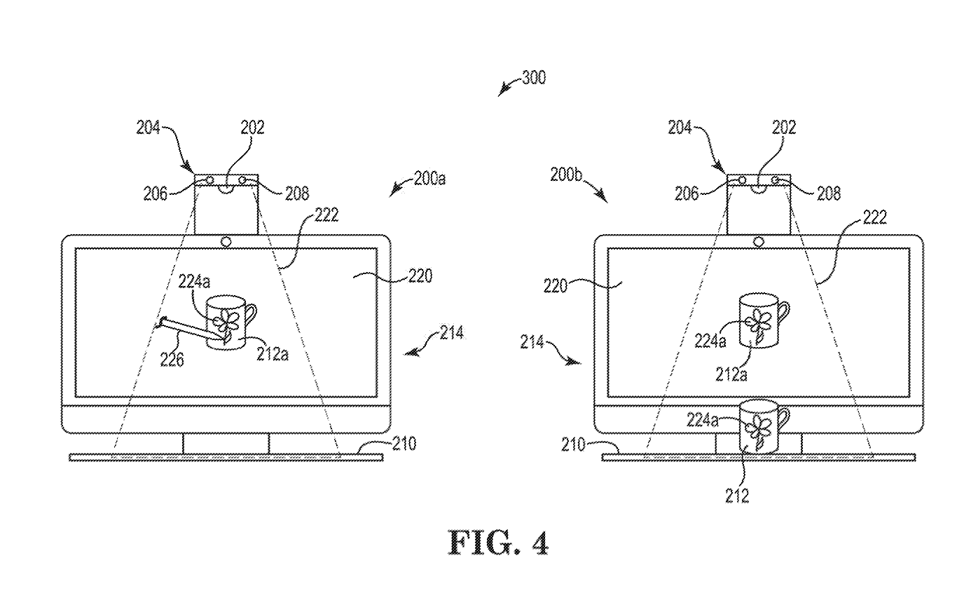

FIG. 4 illustrates an example system 300 suitable for remote collaboration. System 300 includes at least two systems 200a and 200b, each being similar to system 200 described above. In this example, object image 212a of object 212 positioned at system 200b can be communicated on displays 220 of both systems 200a, 200b. Display 220 of system 200a can be a touch screen capable of detecting and tracking one or multiple touch inputs by a user (not shown) in order to allow the user to interact with software being executed by device 214 or some other computing device. A user can employ stylus 226 on touch screen display 220 of system 200a, for example, to draw or otherwise indicate image 224a onto object image 212a. Image 224a can be communicated with system 200b and displayed on object image 212a viewable on display 220 of system 200b. Image 224a can also be projected by projector 202 of system 200b onto real object 212. Systems 200a and 200h can be located remote from one another and provide interactive, real-time visual communication and alterations of augmented images to users of each system 200a and 200b.

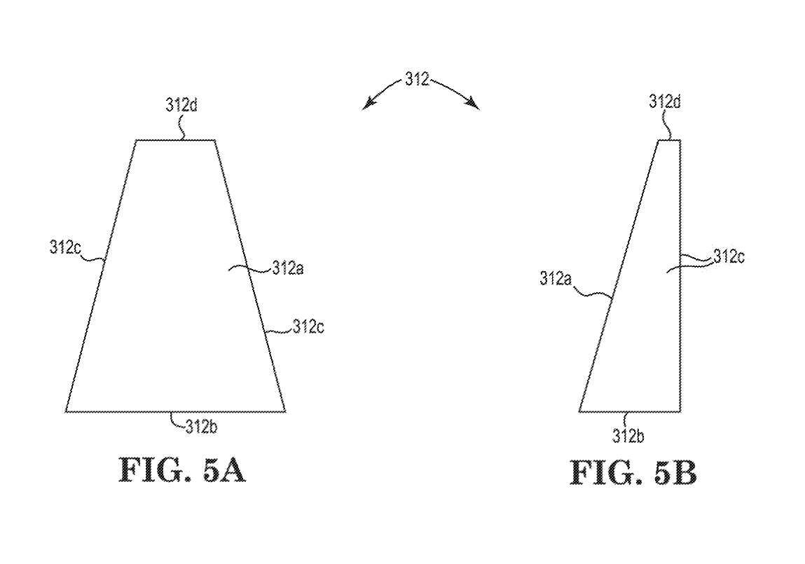

FIGS. 5A and 5B illustrate an example display object 312 usable with system 200. Object 312 can be any suitable shape useful in being an augmented picture frame or video communicator. Object 312 can be wedge shaped and include a projection surface 312a oriented at an acute angle to a bottom surface 312b. Wedge object 312 can also include side surfaces 312c and top surface 312d as appropriate to support projection surface 312a. In some examples, surfaces 312b, 312c, and 312d can also function as projection surfaces. At least projection surface 312a is relatively smooth and is made of any suitable material for receiving and displaying projected images.

FIG. 6 illustrates an example image system 400 similar to system 300 described above. System 400 includes communication objects 312. Objects 312 are positionable within FOVs 422, and in particular, with FOVs of projectors 402. Devices 414 of systems 400a and 400b each include a camera unit 428 to take images of a user while he or she is positioned in front of display 420. In some implementations, camera unit 428 is a web based camera. In operation, camera unit 428 of system 400a captures images of a user positioned in front of display 420 and communicates with system 400b to project a user image 424a onto object 312 with projector 402 of system 400b. Conversely, camera unit 428 of system 400b captures images of a user positioned in from of display 420 and communicates with system 400a to project a user image 424b onto object 312 with projector 402 of system 400a. Images 424a and 424b can be video images and, in operation, objects 312 can be employed as video communicators and can provide real-time communication and collaboration between users. Objects 312 can be positioned anywhere within the projection area (FOV) of projector 402. Users can use the vertical surface of displays 420 and the horizontal surface of surface 410 to display other images or additionally display images 424a, 424b. The angled surface of objects 312 can provide users with enriched viewing.

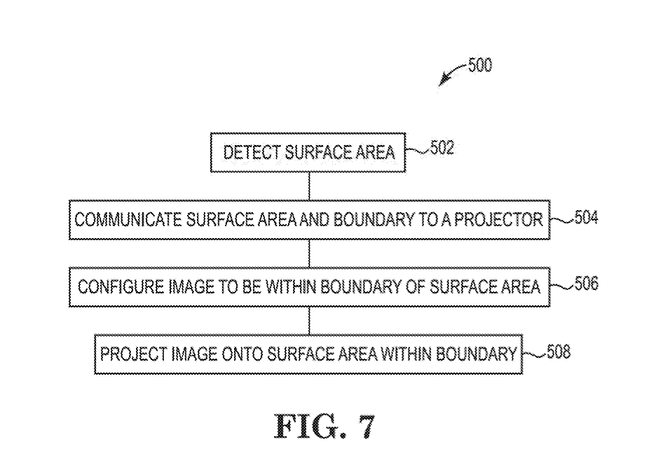

FIG. 7 illustrates a flow diagram illustrating an example method 500 of displaying an augmented image. At step 502, a surface area of an object is detected with a sensor cluster. The surface area includes a boundary. At step 504, the surface area and boundary are communicated to a projector. At step 506, an image is configured to be within the boundary of the surface area. At step 508, the image is projected onto the surface area within the boundary.

Although specific examples have been illustrated and described herein, a variety of alternate and/or equivalent implementations can be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. An in system, comprising:
a sensor cluster module to detect and capture surface area values of an object and communicate the surface area values to a computing device; and
a projector to receive boundary values related to the surface area values of the object and image content of an image from the computing device., the projector to project the image content within and onto the surface area of the object.

2. The image system of claim 1, wherein the object is a three dimensional object.

3. The image system of claim l, wherein the object is wedge shaped including a projection surface oriented at an acute angle to a bottom surface.

4. The image system of claim 1, wherein the sensor cluster module and the projector are calibrated to communicate with each other in real time.

5. The image system of claim 4, wherein the sensor cluster module includes at least a depth sensor and a camera.

6. The image system of claim comprising:
an object platform to position the object within a detection area of the sensor cluster module and a projection area of the projector.

7. An image system comprising:
a sensor cluster module to detect and capture a surface area of an object;
a computing device, comprising:
a memory to store instructions and receive initial surface area values of the object and image values of a first image;
a processor to execute the instructions in the memory to:
transform the initial surface area values to boundary line values;
identify an object boundary from boundary line values;
transform the image values to be within a vector space defined by the boundary line values; and
generate aligned image values confined by the object boundary; and
a projector to receive the aligned image values, generate an aligned image from the aligned image values, and project the aligned image onto the object.

8. The image system of claim 7, comprising:
a remote computing device to display and communicate with the computing device.

9. The image system of claim 7, wherein the first image is generated on the remote computing device and communicated to the projector to project onto the object.

10. A method of displaying an image, comprising:
detecting a surface area of an object with a sensor cluster, wherein the surface area includes a boundary;
communicating the surface area and boundary to a projector;
configuring an image to he within the boundary of the surface area; and
projecting the image onto the surface area within the boundary.

11. The method of claim 10, comprising:
communicating an object image to a device including a display.

12. The method of claim 11, comprising:
displaying an object image of the object on the display.

13. The method of claim 11, wherein the display is a touch sensitive display.

14. The method of claim 12, wherein the image can he communicated from the display onto the surface area.

15. The method of claim 10, comprising:
positioning a video communicator within a projection area of the projector.
